(19) United States
(12) Patent Application Publication
(10) Pub. No.: US 2006/0248793 A1
(43) Pub. Date: Nov. 9, 2006

(54) Method for making fungi compatible artificial snow

(76) Inventor: Jon Y. Takemoto, North Logan, UT (US)

Correspondence Address: Utah State University Research Foundation, Suite 101, 570 Research Park Way, North Logan, UT, 84341, US

(21) Appl. No.: 11/418,002

(22) Filed: May 3, 2006

Related U.S. Application Data
(60) Provisional application No. 60/678,010, filed on May 4, 2005.

(51) Int. Cl. A01G 13/00

(52) U.S. Cl. 47/2

(57) ABSTRACT

A method for eliminating the fungicidal activity that is inherent in bacterial solutions used as ice nucleating agents is described and involves raising the pH of ice nucleating bacteria solutions.

### BACKGROUND

### A) Bacterial Ice Nucleation

Crystallization into ice begins with a nucleation event. In the 1960's, it was realized that biological agents could nucleate water to form ice and this characteristic in bacteria has been reported (U.S. Pat. Nos. 5,137,815; 5,223,412; and 5,413,932). Pioneering studies by Maki (25) on the enhanced ice nucleating capabilities of decaying leaves showed that the plant bacterium, P. syringae, is a major ice nucleating agent. Separate studies by Hoppe and later Lindow (22) on the origins of crop freezing showed that P. syringae strains are ice nucleators and a major cause of frost damage in crops. In the presence of these plant bacteria, ice formation begins at about −1° C. (˜30° F.). Other bacteria including Pseudomonas fluorescens and Erwinia sp. and certain fungi, lichen and insects are capable of ice nucleation (14). Why bacteria have this activity, however, is not certain. Plant bacteria such as P. syringae are epiphytes, and it is proposed that they have a competitive advantage for acquiring nutrients from ice-damaged plant tissue (11).

Many of the biochemical and molecular details of P. syringae ice nucleation activity have been determined (12, 31, 29, 28, 23, 42). The activity is attributed to a macromolecular complex composed of ice nucleation active (INA) protein located in the P. syringae outer membrane. With largely repetitive peptide sequences (approximately 81% of the total sequence), INA protein is predicted to form anti-parallel beta sheets that resemble the hexagonal shape of ice crystals (18). With phosphatidylinositol (20) and mannose (40), INA protein forms aggregates, the size of which determines the crystallization temperature (9).

### B) Artificial Snow

Artificial snow production based on P. syringae ice nucleation occurs worldwide and on a large scale. Developed in the 1980's by DNA Plant Technology Corp. and later by Eastman Kodak Chemical Co., the dominant product is SnoMax® currently produced and sold by York International, Inc. In 2002, more than 300 SnoMax®-based artificial snow-making facilities were operating (more than half of the world's ski resorts) including those at all of the venues of the 2002 Salt Lake City Winter Olympics (Deer Valley, Park City, Utah Olympic Park, Snowbasin, Soldier's Hollow) (http://www.snowmax.com/products/snomax/). Other Utah ski areas that use SnoMax® are Snowbird, The Canyons, and Solitude.

SnoMax® is composed entirely of material derived from P. syringae strain 31R originally isolated by S. Lindow in the 1970's from freeze-damaged crops (22). To produce SnoMax®, P. syringae 31R is grown by large-scale fermentation, pelleted, and freeze-dried. Finally, the packaged product is irradiated before shipping. To make snow, SnoMax® is hydrated, metered into a water supply, and then projected over ski areas through snow making guns as the water freezes. Making snow with SnoMax® is done at temperatures as high as 30° F. whereas other (chemical) ice-nucleators are not effective at temperatures above 15-20° F. Large quantities of seeded water and SnoMax® are required. For example, at Mt. Buller (NE of Melbourne, AU), coverage of a 50 m×50 m area with 150 cm depth of snow, requires 187,500 L of water,
(http://ski.mtbuller.com.au/reports/snowmaking.html). This requires about 1.6 kg of dry form SnoMax®. The use of SnoMax® in the USA is claimed to be regulated
http://www.snowmax.com/products/snomax/) although documentation for this can not be verified.

### C) P. syringae 31R is Fungicidal

In addition to ice nucleation, a major property of P. syringae strains is the production of antimicrobial cyclic lipodepsipeptides (U.S. Pat. Nos. 5,830,855 and 6,310,037). Two kinds of cyclic lipodepsipeptides are produced: the smaller syringomycins (˜1200 Mᵣ) and larger syringopeptins (˜2500 Mᵣ). They are both physically associated with cell surfaces and are also released in large aggregates (15). The syringomycins are strongly inhibitory to many fungi (5, 36) and the syringopeptins are bacteriocidal (10, 15). The syringomycins have been investigated by Takemoto and colleagues for over a decade—particularly their chemical structures, biological diversity and roles, and mechanisms of action (38). Chemically stable, the fungicidal activities of the syringomycins are not affected by freezing, heating to 60° C., acidity, or enzymatic digestion. Thus, they are predicted to remain active after the treatments used to produce SnoMax®. The fungicidal properties of P. syringae strains that are imparted by the syringomycins are prominent. Biological control applications based on syringomycin-producing P. syringae strains have been developed to control postharvest fruit fungal diseases in lieu of conventional pesticides (3) and the syringomycins are lead compounds for the development of novel antifungal therapeutics in medicine (6, 36).

### D) Mycorrhizal Fungi and Subalpine Forests

Many fungi form symbioses with the roots of plants that are essential for the survival of the plant host. These symbioses are called mycorrhizae, and the fungal partner in the relationship penetrates into the root tissue so that it is thoroughly integrated into the plant root without pathogenic effects. Nearly all wild plants depend on mycorrhizal associations, and it is the norm in natural environments such as forests. Two major types of mycorrhizal associations are: ectomycorrhizae (ECM) and arbuscular mycorrhizae (AM). All tree species and most woody shrubs occurring in the subalpine forests of the western USA form ECM (13). In ECM, the fungal partner penetrates into the root tissue but remains intercellular, and the hyphae facilitate the exchange of nutrients and other materials between the symbionts. Of several hundred known species of ECM fungi, most are members of the Basidiomycota and Ascomycota that produce mushrooms and truffle-like fruiting bodies (27, 39). A large number of species of ECM fungi exist in the subalpine zone of the western USA where ski areas are located although a species tally for the mixed spruce, fir, aspen, and pine forests in this region has not been done. Many ECM fungi are either obligate symbionts or difficult to grow in culture, but a number do grow readily in culture and can be manipulated under laboratory conditions. AM association fungi are obligate symbionts and will not grow without a host plant. Members of the Glomeromycota, AM fungi associated with herbaceous plants and grasses of subalpine forests and are not host specific. In AM associations, the fungal hyphae form a highly branched structure called an arbuscule that is eventually absorbed by the host cell and is thought to be the site where nutrient exchange between the symbionts occurs (13).

AM and ECM fungi play critical roles by increasing the water and nutrient absorptive areas of plant roots, and they afford some protection against root pathogens. In exchange, the host plant provides carbohydrates necessary for fungal growth (13). In an ecosystem context, mycorrhizal fungi form a subsurface network that connects different plants to one another, enabling nutrient exchange between the interconnected hosts (7). In this way, most members of the forest community function as a single unit. Each fungal species of the mycorrhizal community will have ecological attributes that make it adaptive for its host and environment. As a consequence, it can be expected that each forest community will have selected for an assemblage of mycorrhizal fungi that is best adapted to the conditions prevailing at a particular location.

The P. syringae cyclic lipodepsipeptide syringomycins and SnoMax® are predicted to inhibit mycorrhizal fungi. Results obtained since the previous submission of this proposal in 2004 suggest this to be the case (see Table 1). If so, sustained and widespread application of SnoMax® will almost certainly result in dynamic changes in mycorrhizal populations and the forest community structure. The more susceptible fungal members of the AM and ECM communities could make way for proliferation of the least susceptible members. The consequent long-term impact on the forest ecosystem as a whole is unknown.

The present invention will have major implications for the environmental management of the nation's forest ski areas. Because of the prominence of the recreational ski industry, this invention would also have a major impact on the winter recreational economy. On-demand production of snow using SnoMax® is currently a financial boon for ski resorts. However, if the practice causes a decline of forest trees and flora, the attractiveness of winter skiing and the recreational experience it affords will be compromised, and the financial benefits will be reduced. Even more costly might be the large environmental consequences. The potential problem is not confined to the USA since SnoMax® is used by more than half of the world's ski resorts. The present invention eliminates the potential detrimental environmental effects of ice nucleating products, namely the anti-fungal activity of ice nucleating bacteria such as P. syringae that contain cyclic lipodepsipeptide syringomycins.

### SUMMARY OF THE INVENTION

The ice-nucleating plant bacterium, Pseudomonas syringae strain 31R, is the basic ingredient in SnoMax®, a product currently used for large-scale artificial snow production at many recreational ski areas. Since production of fungicidal cyclic lipodepsipeptides is a common property of P. syringae, the ability of strain 31R to produce and whether SnoMax® contains these compounds were studied.

Cell extracts of strain 31R cultures and SnoMax® were tested for fungicidal activity against several fungal species including yeasts, filamentous fungi, and ectomycorrhizal species. Chromatographic and mass spectral analyses were used to chemically identify the fungicidal components of these extracts.

Strain 31R and the SnoMax® extracts were found to have strong fungicidal activity against all fungal species tested including ectomycorrhizal fungi. Chemical analyses revealed that the activities were due to the production of cyclic lipodepsipeptides. Structure determination of the purified fungicidal material in SnoMax® indicated that syringomycin E and G and syringopeptin 22B are the principal cyclic lipodepsipeptide components. Tests are currently being conducted to determine the effects of P. syringae strain 31R and SnoMax® on endomycorrhizal fungi.

P. syringae strain 31R produces and SnoMax® contains significant amounts of fungicidal cyclic lipodepsipeptides. This suggests that the use of SnoMax® for making artificial snow may impact the health of forest ecosystems in recreational ski areas by suppressing mycorrhizal fungi.

The present invention relates to a method for eliminating the fungicidal activity of an ice nucleating bacteria solution comprising raising the pH of said ice nucleating bacteria solution to a high pH under sufficient conditions to eliminate the fungicidal activity of said ice nucleating bacteria solution.

Another aspect of the present invention is a method for enhancing fungi compatible artificial snow making comprising applying a fungi compatible ice nucleating bacteria solution produced according to this invention to a target area under conditions suitable for artificial snow making.

### DESCRIPTION OF THE FIGURES

FIG. 1 shows fungicidal inhibition of R. pilimanae by culture filtrates of P. syringae strain 31R. Ten μL quantities of undiluted filtrate (1) and multiple aliquots of 2-fold dilutions of the filtrate (2-9) were applied to potato dextrose agar plates with freshly streaked R. pilimanae. The plate was incubated for 1 day at 28° C. The cleared spots show fungicidal growth inhibition.

FIG. 2 shows fungicidal inhibition of R. pilimanae by acidified acetone extracts of P. syringae 31R. Ten μL quantities of undiluted (1) and 2⁻¹ (2), 2⁻² (3) and 2⁻³ (4) dilutions of the extracts were applied to potato dextrose agar plates with freshly streaked R. pilimanae. The plate was incubated for 1 day at 28° C. The cleared spots show fungicidal growth inhibition.

FIG. 3 shows SnoMax® inhibition of R. pilimanae. SnoMax® (1 g) was suspended in 5 ml H₂O. One ml was mixed with 1 ml of acidified acetone, centrifuged, and the supernatant was recovered. An aliquot (200 μL) of the extract was evaporated to near dryness at 40° C. H₂O (100 μL) was added and the mixture evenly suspended. Ten μL each of the SnoMax® suspension, extract, and H₂O control were spotted onto a fresh lawn of R. pilimanae on PDA medium and incubated at 28° C. for 24 h.

FIG. 4 shows the effect of pH on the antifungal activity of Snomax suspensions. SnoMax was mixed and suspended with water for 1 hour at room temperature, the pHs were adjusted to 6, 8, or 10 by titrating with dilute solutions of NaOH and HCl, and the suspensions incubated at the final pHs for 1 hour at room temperature. The suspensions were then freeze dried. The freeze dried powders were extracted with acidified acetone, centrifuged, and the supernatant fractions recovered. Acetone was evaporated off at 45° C. and the residues serial diluted (2 fold) in water. Ten microliter aliquots of 2⁻¹ (a), 2⁻² (b), and 2⁻³ (c) dilutions were deposited on a freshly prepared lawn of Rhodotorula pilimanae onto potato-dextrose-casamino acids (PDA-CA) agar medium prepared in Petri dishes. A 10 microliter aliquot of pure syringomycin E (1 mg per ml) was also applied (d). The Petri dishes were incubated at 28° C. for 36 hours. Result: pH 8 and 10 treatments eliminated the antifungal activities of snomax suspension and of syringomycin E, the latter serving as positive control.

FIG. 5 shows the effects of SnoMax on root colonization of onion plants by certain fungi. The 2ˆ-3 dilution was 12.5 g SnoMax/Liter of H₂0, and the 2ˆ-4 dilution was 6.25 g SnoMax/Liter of H₂O.

### DETAILED DESCRIPTION OF THE INVENTION

The present invention relates to a method for eliminating the fungicidal activity of an ice nucleating bacteria solution comprising raising the pH of said ice nucleating bacteria solution to a high pH under sufficient conditions to eliminate the fungicidal activity of said ice nucleating bacteria solution. The ice nucleating bacteria solutions that are the subject of the present invention are those bacteria solutions that are combined with a water solution and that have the ability to accelerate, catalyze or enhance the transition of water solution containing the ice nucleating bacteria solution from a liquid phase to a solid phase under such conditions where such phase transition would not occur in the absence of the ice nucleating bacteria solutions. This is typically evidenced by the occurrence of the phase transition (or freezing temperature) of a water solution containing ice nucleating bacteria solution from liquid to solid at a temperature above or higher than where the same water solution would make the same phase transition in the same time period in the absence of the ice nucleating bacteria solution. Preferably, the higher freezing temperature for the water solution containing the ice nucleating bacteria solution is at least 1° C., more preferably at any higher freezing temperature that is at least about 1° C. higher to at least about 10° C. higher, most preferably at least about 4° C. higher.

In addition to the ability to raise the freezing temperature, the water solution containing the ice nucleating bacteria solution will have fungicidal activity. Fungicidal activity includes the ability to kill a significant amount of fungi into which the water solution containing the ice nucleating bacteria solution come in contact. Killing a significant amount of fungi means the killing of a statistically significant number of the population of fungi into which the water solution containing the ice nucleating bacteria solution come in contact (the fungal population), preferably an amount that is more than the statistical error in measuring the size of the fungal population up to and including 100 percent lethality, including all intermediate kill amounts between the statistical error in measuring the size of the fungal population and 100 percent lethality. More preferably, the kill amount of the fungal population or the lethality is at least about 50 percent of the fungal population, more preferably more than about 75 percent of the fungal population and most preferably more than about 90 percent of the fungal population.

Ice nucleating bacteria solutions include solutions that contain an ice nucleating bacteria selected from the group consisting of Pseudomonas syringae, any species of the Pseudomonas genus, any species of the Xanthomonas genus and any species of the Erwinia genus. Preferred ice nucleating bacteria include bacteria species of the Pseudomonas genus, and particularly P. syringae and most preferably P. syringae strain 31R Ice nucleating bacteria solutions can be grown in fermentation tanks and harvested by centrifugation or filtration and suspended in water to a cell concentration of about 10⁻¹⁰ colony forming units per ml.

Once an ice nucleating bacteria solution has been identified and prepared, the present invention provides for a method to eliminate the fungicidal activity of the ice nucleating bacteria solution. The method includes raising the pH of the ice nucleating bacteria solution to a high pH under sufficient conditions to eliminate the fungicidal activity of said ice nucleating bacteria solution.

Raising the pH of the ice nucleating bacteria solution can be accomplished by adding a base to the ice nucleating bacteria solution or titrating the ice nucleating bacteria solution with a basic solution. Suitable bases are known in the art and preferably include salts of NaOH, KOH, MgOH and CaOH and aqueous solutions of these salts. NaOH is a preferred base. In this manner, the pH of the ice nucleating bacteria solution is raised to a high pH. A high pH is any pH above 7.0, preferably at least above 7.5. More preferably, the pH is raised to from about 7.1 to about 8.5, even more preferably the pH is raised to from about 7.5 to about 8.0, and most preferably, the pH is raised to about 8.0.

The raising of the pH occurs under sufficient conditions to eliminate the fungicidal activity. Sufficient conditions include raising the pH for a sufficient time period and at a sufficient temperature to eliminate the fungicidal activity. A sufficient time period is preferably from about 1 min to about 60 minutes, more preferably from about 1 minutes to about 30 minutes, most preferably about 15 minutes. A sufficient temperature is preferably from about 10° C. to about 50° C., more preferably from about 20° C. to about 40° C., most preferably about 25° C. Those skilled in the art will appreciate that the preferred temperature and time period are related and each will depend on each other. For example, the optimal time period for raising the pH may be less at a higher temperature. The optimal or preferred temperature or time period can be determined if one or the other is held constant using routine experimentation.

Once the pH of the ice nucleating bacteria solution has been raised to a high pH using a suitable base under sufficient conditions to eliminate the fungicidal activity, the pH can immediately lowered to the pH of the ice nucleating bacteria solution before treatment with the base, the pH can be lowered at a later time or it can remain at the high pH. The ice nucleating bacteria solution after treatment at high pH, and either after or without readjustment of the pH to the pH existing before treatment at high pH, can be maintained as a solution or can be dried to a powder form for reconstitution later. Reconstitution yields the ice nucleating bacteria solution without fungicidal activity. Typically, the pH will be readjusted when the ice nucleating bacteria solution is combined with a water solution to yield a water solution containing an ice nucleating bacteria solution. This water solution containing an ice nucleating bacteria solution is typically what is applied or used to raise the freezing temperature and cause the formation of ice.

Another aspect of the present invention is a method for enhancing fungi compatible artificial snow making comprising applying a fungi compatible ice nucleating bacteria solution produced according to this invention to a target area under conditions suitable for artificial snow making. Snow making includes both the formation of new snow or ice, or the maintenance of an ice condition or frozen state of water.

In this aspect of the invention, the target area can include, for example, a recreation area or a permafrost maintenance zone. A recreation area includes ski slopes, ski resorts, skating ice rinks, luge and bobsled runs, ski jump ramps, any winter Olympic event venue, theatrical or cinematic locations and/or scenery. A permafrost maintenance zone includes many locations in the artic tundra where destruction or melting of the permafrost can be detrimental, dangerous or economically disadvantageous. This includes facilities located in the tundra such as, for example, refineries, drilling sites, airports, runways, power generating equipment, port facilities, railroad beds, pipeline footings, and roads.

Application of the ice nucleating bacteria solution can occur directly or after mixing with a water solution make a water solution containing an ice nucleating bacteria solution. As described, the ice nucleating bacteria solution is often the product of reconstituting a dried ice nucleating bacteria solution powder. Application of ice nucleating bacteria with the starting material being a dried ice nucleating bacteria powder or an ice nucleating bacteria solution is know in the art. What is not known and what is taught be this invention is the necessity and method to inactivate the fungicidal activity of ice nucleating bacteria. The embodiments and aspects of the invention described herein and in the Examples that follow are illustrative of the invention and are not intended to be limiting in any way. Those in the art will appreciate the variations of this invention that are included within the scope of the present invention.

### EXAMPLES

### Example 1

### Production of Syringomycin-like Fungicidal Compounds by Ice Nucleating Bacteria Used in Artificial Snow Making

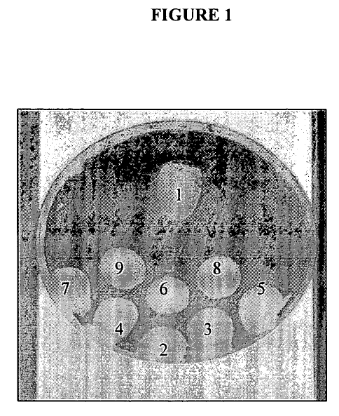

Because P. syringae strains are typically fungicidal, studies were begun in 2002 to analyze the SnoMax® bacterium, P. syringae 31R, for this property. P. syringae 31R was obtained from Dr. Steven Lindow (Univ. California, Berkeley) and grown aerobically on potato dextrose medium. The culture filtrates were strongly fungicidal to Rhodotorula pilimanae (a fungal yeast) (FIG. 1).

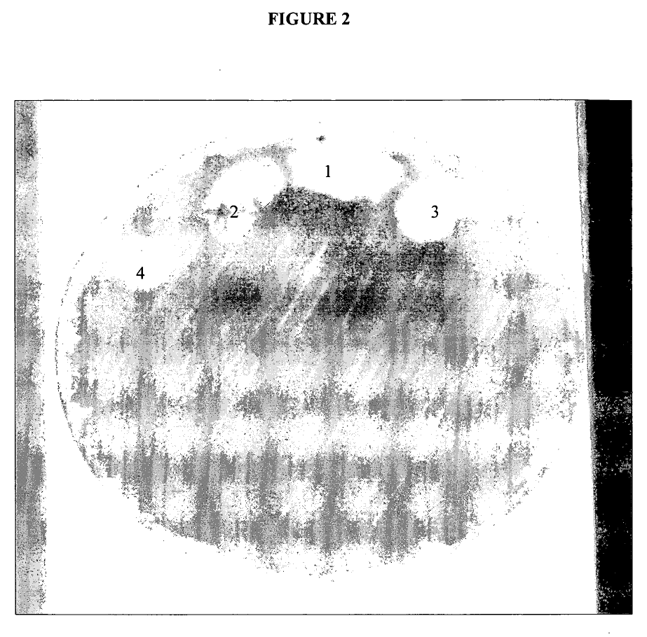

In addition, whole cultures of P. syringae 31R were extracted with acidified acetone and the extracts were processed by procedures used for purification of the syringomycins (1). Such acetone extractions showed potent fungicidal activities resembling those of the syringomycins (FIG. 2).

These preliminary and novel results reveal that the SnoMax® bacterium, P. syringae 31R, is capable of producing fungicidal material that resembles the syringomycins. This material is being propagated into the environment when SnoMax® is used to make artificial snow. If the Mt. Buller rates of SnoMax® application are used, and it is assumed that P. syringae produces 50 mg of syringomycin per 4 L culture (1), then the syringomycin concentration at affected areas may be as high as 19 mg per ml. This level far exceeds the effective fungicidal concentrations of the syringomycins.

During the summer of 2003, Utah State University graduate student Camille Swasey grew batch liquid cultures of P. syringae 31R, extracted the cultures with acetone, and processed the extracts using chromatographic procedures that are normally used to purify cyclic lipodepsipetides of P. syringae (1). HPLC profiles revealed material that closely resembled the syringomycins. Mass spectroscopic analyses of the putative syringomycin peak material identified the material as syringomycin E (MW 1224), the most common small cyclic lipodepsipeptide of P. syringae. The material displayed growth inhibitory activity against R. pilimanae, other yeasts and filamentous fungi typical of syringomycin E.

### Example 2

### Inhibition of Fungal Species and Impact on Fungal Communities by Ice Nucleating Bacteria Used as a Nucleating Agent for Artificial Snow

A) Determination of ECM Fungal Inhibition By SnoMax® Suspensions and P. syringae 31R and SnoMax® Extracts

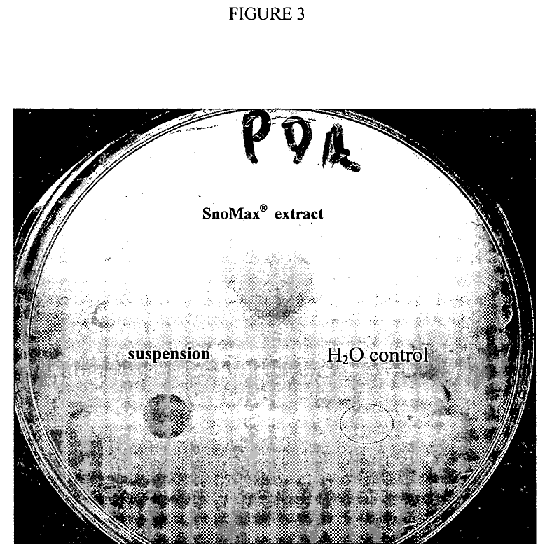

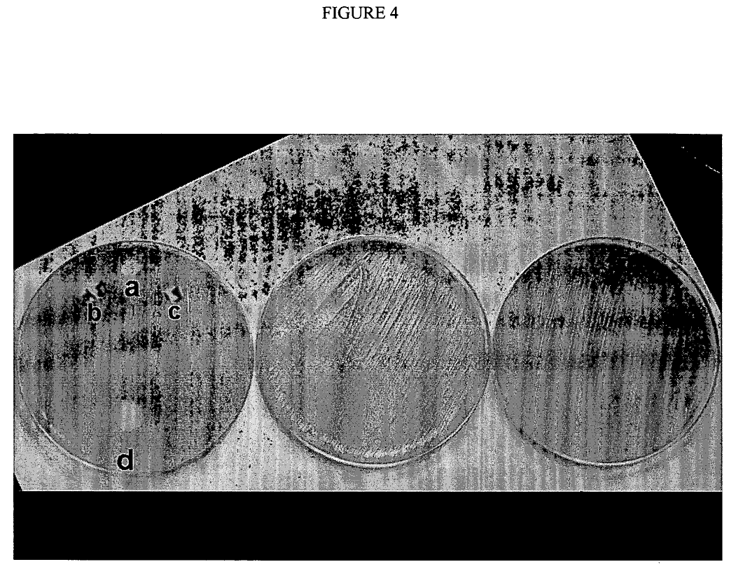

SnoMax® was obtained from the snow making operation of a local Utah ski resort. One gram was suspended in water and an aliquot was extracted with acidified acetone. The extract was dried, suspended in water, and the solutions were tested for inhibitory activity against R. pilimanae grown as a lawn on potato dextrose agar medium (1) (FIG. 3). This assay is determines syringomycin production. The inhibitory activity observed was typical in both character and extent of significant quantities of bioactive syringomycin. Recent studies show that SnoMax® contains significant amounts of syringomycin E. SnoMax® and was also observed to inhibit other fungi including ectomycorrhizal fungi (see Table 1). These results illustrate that SnoMax® possesses significant quantities of fungicidal material. The pH profile for antifungal activity is shown in FIG. 4 and shows that increasing pH eliminates the antifungl activity.

In addition to laboratory studies, ECM fungi that exist in high elevation sites of the Rocky Mountains and that are also culturable in artificial media are studied. These include: Amanita muscaria, Boletus edulis, Hebeloma crustuliniform, Laccaria bicolor, Laccaria laccata, Lactarius deliciosus, Lactarius rufus, Suillus brevipes, Suillus tomentosus, Rhizopogon occidentalis, and Rhizopogon subcaerulescens. Cultures of these fungi are available from the laboratory of Kropp, Utah State University or are obtained from the American Type Culture Collection. Syringomycin-containing extracts from P. syringae 31R and SnoMax® are prepared by methods used for extraction of cyclic lipodepsipeptides (FIG. 2) (1). Briefly, equal volumes of acidified acetone are added to bacterial cultures and SnoMax® suspensions. The mixtures are centrifuged and evaporated to give the aqueous extracts for testing. SnoMax® itself is suspended in water (0.1 g per ml), and the suspension is tested for fungicidal activities.

For testing, the linear growth of the various ECM fungi in the presence and absence (controls) of extracts and SnoMax® suspensions are analyzed. Sterile agar strips (5 cm×1.5 cm, cut from fresh agar plates and placed in sterile plastic petri dishes) are inoculated at one end with a 5 mm diameter inoculum plug of the ECM fungus to be tested. Paper disks (1 cm diameter) are soaked in filter-sterilized extracts and SnoMax® suspensions and placed at the opposite end of the agar strip. Control strips with disks soaked in sterile distilled water are also be prepared. The concentrations of the extracts to be used are based on the independent determination of the minimal inhibitory concentrations needed to inhibit the in vitro growth of the yeast R. pilimanae. Two levels of 2-fold dilutions above and below this concentration are used. The plates are sealed with Parafilm and incubated at room temperature for several weeks. The extent of linear growth is measured and compared. The ages of the inoculum cultures are standardized and all inoculum disks are taken from the actively growing colony margin. At least five replicate SnoMax® inhibition tests are performed for statistical analyses. The inhibition tests are accomplished using modified Melin-Norkrans medium known to support growth of ECM fungi (26).

B) Assessment of SnoMax® Impact on AM Fungal Communities

1) Field Studies

Herbs and grasses that dominate treeless ski slopes form symbioses predominantly with AM fungi. The impact of bacterial snow on the fungal assemblages forming AM with these plants is assessed using SnoMax® treated plots paired with control plots. A similar approach has been used successfully to measure the effect of artificial snow on subalpine herb communities on ski slopes in Europe (41). Potential changes in the AM fungal populations resulting from application of bacterial snow are assessed by comparing fungal community structure, degree of mycorrhizal formation by AM fungi, and soil inoculum potential between SnoMax® treated and control plots.

The impact of bacterial snow on AM fungi are assessed using 10 plot pairs established at a ski area in Utah (Snowbasin). Each plot pair consists of a control plot on a slope where artificial snow is not used and a treated plot on a slope that is managed using SnoMax® applications. Each plot is 6 m×6 m in size. Because the effects of artificial snow on plant communities have been shown to increase with the length of time that artificial snow has been used (41), snow management history of the slope is considered in the selection of plots, and measurements are made annually for three years. Control plots are paired with SnoMax® treated plots that are similar with respect to important factors such as elevation, slope, aspect, and plant community composition, as well as snow management history. The centers of all plots are established using GPS readings, along with compass bearings and measurements taken from recognizable, stable features along the edges of the ski slopes (trees, large boulders, etc.). Plot centers are marked using a method acceptable to the ski area (probably painted wooden stakes pounded into the ground, level with the soil surface).

The soil in each plot is sampled annually using fifteen 10 cm×20 cm soil cores. To account for seasonal variation in fungal activity, sampling is done each year in the Spring (within three weeks after snowmelt), mid July, and again in late September. Three transects are established across each plot at 2 m intervals, and 5 cores are sampled at 1 m intervals along each transect. Sampling is spatially staggered each year to avoid resampling of the same spot. Each soil core is divided into two halves after core contents have been mixed. One half is used to determine the degree of AM formation on roots and to identify AM species. The other half is used to quantify soil inoculum potential.

a) Changes in fungal community structure. Changes in the AM fungal populations resulting from application of bacterial snow is measured by assessing differences in community structure and differences in the degree of mycorrhiza formation by AM fungi. Two variables are computed for each plot to assess changes in community structure of AM fungi: 1) species richness, to evaluate effects of SnoMax® on overall community diversity, and 2) species evenness, to evaluate effects of SnoMax® on the distribution of species abundance. The total number of species in the plot is taken as species richness in our study. Richness indices such as the Margalef index or the Menhinick index (24) are not needed in the study because we are comparing replicate plots within a single community rather than different communities where different sample sizes may cloud richness estimates. The evenness index of Hill (24) are used to assess evenness since this index is unaffected by occurrence of rare species in samples. Hill's evenness index is E=(1/λ)/e^{H1} where λ=Simpson's diversity index (34) and H1=Shannon's diversity index (33). The effects of SnoMax® and year on richness and on evenness are assessed using an analysis of variance of a one-way factorial in a randomized block design with repeated measures in time. In addition, data on individual species within the community is analyzed, using both univariate (likely, an analysis of variance of a one-way factorial in a randomized block design with repeated measures in time) and multivariate (e.g., ordination, nonparametric multivariate t-test) methods.

AM species are identified using chlamydospores harvested from the soil. The sucrose centrifugation method of Jenkins (17) is used to purify and concentrate the chlamydospores needed for identification. Briefly, the sieved soil from each core is collected in 2 liter beakers and allowed to settle after mixing. The suspension is decanted through a 270 mesh sieve and the collected residue is rinsed into a 50 ml centrifuge tube, centrifuged, and again centrifuged in a sucrose solution before spores are collected on a 325 mesh sieve for subsequent species identification. Identifications are carried out after a visit to the NSF-supported International Culture Collection of Vesicular Arbuscular Mycorrhizal Fungi (INVAM) at West Virginia University at the beginning of the project to learn to identify members of the Glomeromycota. Spore samples that cannot be identified to species are assigned to recognizable taxonomic units based on morphology and included in the analysis.

b) Degree of AM formation. Soil core contents are washed on a 20 mesh screen to remove extraneous debris and plant roots. Roots sieved from the soil cores are evaluated for AM formation by selecting a root sample of a specified fresh weight from each core, then cutting roots into sections 1-2 cm long and storing them in formaldehyde acetic acid (FAA) until use. Later, the roots are subjected to the clearing and staining procedure of Kormanick and McGraw (19) and examined microscopically for AM fungi. Briefly, washed root samples are covered in 10% KOH, autoclaved, and rinsed in water. They are then treated with alkaline H₂O₂, rinsed, and briefly placed in 1% HCL before staining in acid fuchsin-lactic acid. Assessment of AM formation is done using the gridline intersect method (8, 19). After destaining, the root sections are suspended in water in a Petri dish over a grid for microscopic examination. Formation is quantified by tallying mycorrhizal and nonmycorrhizal root sections contacting the grid. The effects of SnoMax®, year, and time of sampling on degree of AM formation and presence of vesicles and arbuscules (measured as a quantity of mycorrhizal sections) is assessed using an analysis of variance of a one-way factorial in a randomized block design with repeated measures in time, in which the plot pairs define blocks. Care will be taken to meet assumptions of the statistical model. Computations are done using Proc MIXED in SAS/STAT®.

c) Soil inoculum potential. Half of the soil from each of the cores taken in the sampling described above are used to determine soil inoculum potential using a greenhouse bioassay. The soil samples from each plot are pooled and thoroughly mixed before being sieved to remove coarse debris. Soil from each plot is diluted with autoclaved soil obtained at the study site in a 10-fold dilution series to 10⁻³. Ten replicate plastic Konetainers (Stuewe and Sons, Inc., Corvallis, Oreg.) are filled with soil for each dilution from each plot and planted with a suitable trap plant such as Sudan grass. After 6 weeks growth under greenhouse conditions, the plant roots are extracted from the Konetainers, washed, and then cleared and stained as described above. The roots from each plant are scored as either being mycorrhizal (+) or nonmycorrhizal (−) using a dissecting scope. The most probable number method described by Daniels and Skipper (4) or Porter (30) is used to estimate the number of viable AM propagules in the soil samples. The most probable number method provides estimates of propagule numbers. Although these estimates by nature include some measurement error, they nonetheless provide values that are appropriate for use in analysis of variance. The effects of SnoMax® and year on inoculum potential are assessed using an analysis of variance of a one-way factorial in a randomized block design with repeated measures in time.

2) Effect of syringomycin extracts of P. syringae 31R and SnoMax® and SnoMax® Suspensions

a) Onion Greenhouse studies. In order to test AM fungi, a completely randomized bioassay involving plant hosts was designed. Soil from an area of aspen and wild grasses was obtained to serve as an AM inoculum and was mixed with ¼ sand and ¼ vermiculite. The soil was put in 80 sterile 110 cc. Konetainers and white sweet Spanish onion seeds were planted in each one, as their roots form mycorrhizal associations and are easy to stain when assessing mycorrhizal formation. These were then watered and kept moist until the seeds germinate. The onions were grown in a greenhouse under sodium vapor lights. The onions for this experiment were grown for 8 weeks (1½ weeks to allow germination, the other 6½ they received the treatments).

These were treated with varied concentrations of SnoMax® suspensions, extracts, and P. syringae 31R extracts. The minimal inhibitory concentration of SnoMax® suspensions was determined by combining 0.5 g with 5 ml of water and 2-fold dilutions was applied to a potato dextrose agar plate with freshly streaked R. pilimanae. The minimal inhibitory concentration of both extracts were determined in order to standardize the experiment. Once the concentrations were determined, three appropriate levels of each extract and the suspension were used to water 20 onion plants each at 10 ml per plant twice a week. Two-fold dilutions were prepared from 10 g SnoMax mixed with 100 ml H₂O. A two-fold dilution reduces the concentration of a solution by a factor of two, that is reduces the original concentration by one half. So the 2ˆ-2 dilution was 25 g SnoMax/Liter of H₂O, 2ˆ-3 dilution was 12.5 g SnoMax/Liter of H₂0, and the 2ˆ-4 dilution was 6.25 g SnoMax/Liter of H₂O. The plants treated with the 2ˆ-2 dilution had pretty much no root structure to stain by the time they were harvested, that is why there is no data for that group.

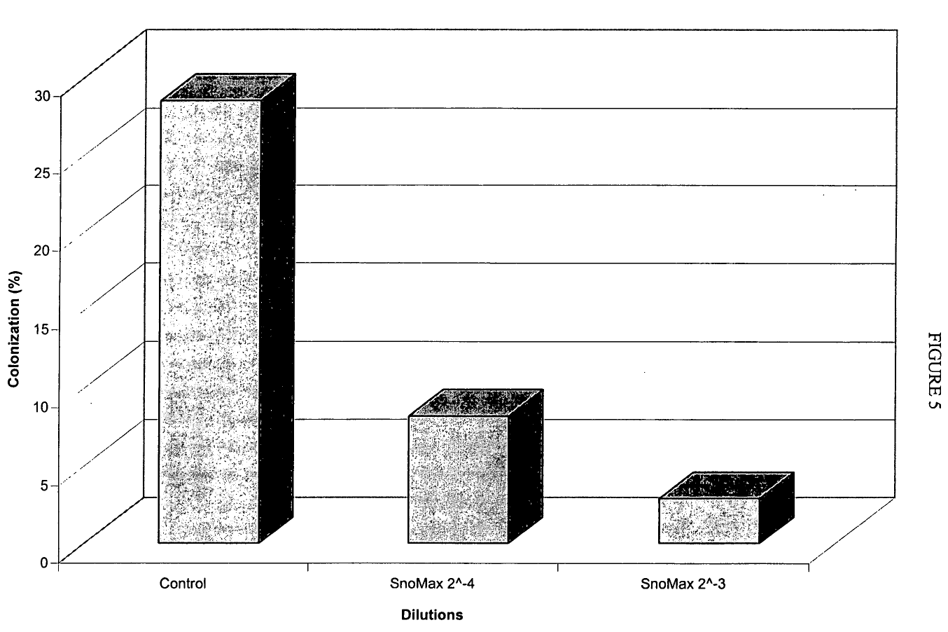

The other 20 plants served as controls and received the same amount of water each week. Plants were misted with water on the weekends to keep the soil moist. The onions will be grown in this manner until adequate root structure has been formed. The roots are harvested and stored in 50% ethanol solution until they are ready for staining. Roots were cleared and stained following a procedure used by Kormanick and McGraw (19). The washed root samples were covered in 10% KOH, autoclaved and rinsed in water. This removed the cell contents and cell wall pigments. The roots were then covered in alkaline H₂O₂, rinsed, and placed in 1% HCl. The roots were stained in acid fuchsin-lactic acid, which caused the mycorrhizal structures to appear bright red to light pink in color. These were stored in a 50% glycerol solution until they were analyzed for the percent root length colonized using the gridline-intersect method (8, 19). The results are shown in FIG. 5 and show that higher concentrations of SnoMax® showed less root colonization by fungi.

b) Other plants. A bioassay is used to test the impact of syringomycin-containing extracts of P. syringae 31R and SnoMax®, and SnoMax® suspensions on AM fungi. The extracts and SnoMax® suspensions are prepared as described above for the high elevation Rocky Mountain site samples. The bioassay is carried out in greenhouses. The effects of the extracts and SnoMax® suspensions is studied using a suitable host plant, such as Sudan grass, grown in soil collected at the ski area near one of our field plots. The soil is first sieved to remove large debris, thoroughly mixed so that the inoculum potential of the soil is uniform, and placed into 110 cc plastic Konetainers for growing the host plants. The plants are grown for 6 weeks in the Konetainers, and the extracts and SnoMax® suspensions are dissolved in the water and applied during watering. Each plant is given 50 ml of water twice weekly. Five concentration levels (volume per volume) of the extracts and SnoMax® suspensions are tested for their effect on formation of roots by AM fungi: The concentrations to be used are based on the independent determination of the minimal inhibitory concentrations needed to inhibit the in vitro growth of the yeast R. pilimanae. Two levels of 2-fold dilutions above and below these concentration are used. Control plants do not receive extracts or suspensions during watering. Twenty-five Konetainers are prepared for each of the 6 treatments. Konetainers from all treatments will be randomly assigned to locations within the greenhouse and the locations reassigned biweekly to minimize effects of environmental variation. After six weeks growth, the roots are harvested by washing them free of soil. Root samples of equal fresh weight are selected from each Konetainer, cut into 1-2 cm sections, and stored in FAA until use. To assess formation, the roots are subjected to the clearing and staining procedure described above (19). AM formation and occurrence of arbuscules, vesicles and hyphae are again measured using the gridline intersect method described above (8, 19). The effects of extract and SnoMax® suspension levels on percentage of mycorrhizae in roots are assessed using either an analysis of variance of a one-way factorial in a completely randomized design or a regression analysis.

TABLE 1
Fungal species inhibited by syringomycin (SR), SnoMax ®,
and SnoMax ® and P. syringae 31R (Ps31R) extracts

| | | Ps31 R | | SnoMax ® | |
|---|---|---|---|---|---|
| Fungus | SR | extract | SnoMax ® | extract | ^{a}Reference |
| Rhodotorula pilimanae | ^{c}+ | + | + | + | 4, 5, ^{b}unpub. |
| Saccharomyces cerevisiae | + | + | + | + | 3, 5, 8, ^{b}unpub. |
| Candida albicans | + | + | + | + | 3, 8, ^{b}unpub. |
| Candida kefyr | + | ^{d}n.t. | n.t. | n.t. | 3 |
| Candida krusei | + | n.t. | n.t. | n.t. | 3 |
| Candida parapsilosis | + | n.t. | n.t. | n.t. | 3 |
| Candida rugosa | + | n.t. | n.t. | n.t. | 3 |
| Candida tropicalis | + | n.t. | n.t. | n.t. | 3 |
| Mucor sp. | + | n.t. | n.t. | n.t. | 3, 7 |
| Microsporium sp. | + | n.t. | n.t. | n.t. | 3 |
| Trichophyton sp. | + | n.t. | n.t. | n.t. | 3 |
| Cryptococcus neoformans | + | n.t. | n.t. | n.t. | 3 |
| Aspergillus fumigatus | + | n.t. | n.t. | n.t. | 1, 3 |
| Aspergillus flavus | + | + | + | + | 1, ^{b}unpub. |
| Aspergillus niger | + | n.t. | n.t. | n.t. | 1, 7, 8 |
| Fusarium moliniforme | + | n.t. | n.t. | n.t. | 1 |
| Fusarium oxysporum | + | n.t. | n.t. | n.t. | 1, 4, 7 |
| Fusarium solani | + | n.t. | n.t. | n.t. | 8 |
| Penicillium expansum | + | n.t. | n.t. | n.t. | 2, 4, 7 |
| Penicillium digitatum | + | n.t. | n.t. | n.t. | 2 |
| Penicillium radulatum | + | n.t. | n.t. | n.t. | 8 |
| Penicillium raistrikii | + | n.t. | n.t. | n.t. | 8 |
| Geotricum candidum | + | + | + | + | 2, 6, 7, 8, ^{b}unpub. |
| Geotricum citri-aurantii | + | n.t. | n.t. | n.t. | 2 |
| Verticillium dahliae | + | n.t. | n.t. | n.t. | 4, 7 |
| Botrytis cinera | + | n.t. | n.t. | n.t. | 4, 7, 8 |
| Ceratocystis fimbriata | + | n.t. | n.t. | n.t. | 7 |
| Ustilago maydis | + | n.t. | n.t. | n.t. | 7 |
| Thielaviopsis basicola | + | n.t. | n.t. | n.t. | 7 |
| Phytophthora infestans | + | n.t. | n.t. | n.t. | 4 |
| Trichoderma atroviridae | + | n.t. | n.t. | n.t. | 4 |
| Rhizoctonia solani | + | n.t. | n.t. | n.t. | 7 |
| Alternaria alternate | + | n.t. | n.t. | n.t. | 8 |
| Aureobasidium pullulans | + | n.t. | n.t. | n.t. | 8 |
| Cladosporium herbarum | + | n.t. | n.t. | n.t. | 8 |
| Rhizopus sp. | + | n.t. | n.t. | n.t. | 7, |
| Laccaria bicolor | + | + | + | + | ^{b}unpub. |
| Suillus brevipes | + | + | + | + | ^{b}unpub. |
| Suillus tomentosus | + | + | + | + | ^{b}unpub. |

Inhibition by
^{a}References (Cited references are published results for syringomycin; results for SnoMax and SnoMax and Pss31R extracts are not yet published).
1. De Lucca, A. J., T. J. Jacks, J. Takemoto, B. Vinyard, J. Peter, E. Navarro, and T. J. Walsh. 1999. Fungal lethality, binding, and cytotoxicity of syringomycin-E. Antimicrob Agents Chemother 43:371-3.
2. Bull, C., M. Wadsworth, K. Sorensen, J. Takemoto, R. Austin, and J. Smilanick. 1998. Syringomycin E produced by biological control agents controls green mold on lemons. Biological Control 12:89-95.
3. Sorensen, K. N., K. H. Kim, and J. Y. Takemoto. 1996. In vitro antifungal and fungicidal activities and erythrocyte toxicities of cyclic lipodepsinonapeptides produced by Pseudomonas syringae pv. syringae. Antimicrob. Agents Chemother. 40:2710-2713.
4. Fogliano, V., A. Ballio, M. Gallo, S. Woo, F. Scala, and M. Lorito. 2002. Pseudomonas lipodepsipeptides and fungal cell wall-degrading enzymes act synergistically in biological control. Mol Plant Microbe Interact 15:323-33.
5. Zhang, L., and J. Y. Takemoto. 1987. Effects of Pseudomonas syringae phytotoxin, syringomycin, on plasma membrane functions of Rhodotorula pilimanae. Phytopathology 77:297-303.
6. Gross, D., Y. S. Cody, J. Proebsting, G. K. Radamaker, and R. A. Spotts. 1983. Distribution, population dynamics, and characteristics of ice nucleation-active bacteria in deciduous fruit tree orchards. Appl. Environ. Microbiol. 46:1370-1379.
7. DeVay, J. E., C. F. Gonzalez, and R. J. Wakeman. 1978. Comparison of the biocidal activities of syringomycin and syringotoxin and the characterization of isolates of Pseudomonas syringae from citrus hosts. Proc. 4^{th} Int. Conf. Pathol. Bacteriol.—Angers, p. 643-650.
8. Volksch, B., and H. Weingart. 1998. Toxin production by pathovars of Pseudomonas syringae and their antagonistic activities against epiphytic microorganisms. J Basic Microbiol 38:135-45.
   ^{b}unpub=unpublished results of Takemoto, J. Y., B. R. Kropp, and C. Swasey. 2004. Utah State University
   ^{c}+=fungicidal ^{d}n.t.=not tested

### Example 3

### Treatment of Ice Nucleating Bacteria Solutions with High pH

Ice nucleating bacteria solutions are made as described on the product package. The pH of the solutions is measured and is 8.0. The ice nucleating bacteria solution is then mixed with NaOH, 0.01M at a ratio of 100:1 ice nucleating bacteria:NaOH for a period of 30 minutes to achieve a pH greater than at least about 8.4. The pH of the ice nucleating bacteria solution is then either adjusted back to its original pH or left at the adjusted pH.

### Example 4

### Non-Inhibitory Activity of Ice Nucleating Bacteria After Treatment at High pH

After treatment of ice nucleating bacteria as described in Example 3, methods as described in Examples 1 and 2 are repeated to measure the decrease in fungicidal activity of the ice nucleating bacteria solutions. The results show a significant decrease in the fungicidal activity after treatment with high pH.

### Example 5

### Retained Ice Nucleating Capability of Ice Nucleating Bacteria After Treatment at High pH

Ice nucleating bacteria solutions that have been treated as described in Example 3 are exposed to reduced temperatures and freezing points calculated and compared to the solutions prior to treatment. No significant change in freezing point is indicated. In addition, the ability to cause freezing under ski slope conditions is measured by volume and amount of snow produced under the same environmental conditions using ice nucleating bacteria solutions with and without high pH treatment and no significant difference in the ability to make snow, the quality of the snow or the quantity of the snow is indicated.

### REFERENCES FOR PATENT APPLICATION EXCLUDING TABLE 1

1. Bidwai, A. P., L. Zhang, R. C. Bachmann, and J. Y. Takemoto. 1987. Mechanism of action of Pseudomonas syringae phytotoxin, syringomycin. Stimulation of red beet plasma membrane ATPase activity. Plant Physiol. 83:39-43.
2. Bruns, T. D., T. M. Szaro, M. Gardes, K. W. Cullins, J. J. Pan, D. L. Taylor, T. R. Horton, A. Kretzer, M. Garbletto, and Y. Li. 1998. A sequence database for the identification of ectomycorrhizal basidiomycetes by phylogenetic analysis. Mol Ecol 7:257-272.
3. Bull, C., M. Wadsworth, K. Sorensen, J. Takemoto, R. Austin, and J. Smilanick. 1998. Syringomycin E produced by biological control agents controls green mold on lemons. Biol Control 12:89-95.
4. Daniels, B. A. and H. D. Skipper. 1982. Methods for the recovery and quantitative estimation of propagules from soil. In Methods and Principles of Mycorrhiza Research, Ed N. Schenck, APS Press, St. Paul.
5. De Lucca, A., and T. Walsh. 1999. Antifungal peptides: Novel therapeutic compounds against emerging pathogens. Antimicrob Agents Chemother 43: 1-11.
6. De Lucca, A. J., T. J. Jacks, J. Takemoto, B. Vinyard, J. Peter, E. Navarro, and T. J. Walsh. 1999. Fungal lethality, binding, and cytotoxicity of syringomycin-E. Antimicrob Agents Chemother 43:371-3.
7. Finlay, R. D., and D. J. Read. 1986. The structure and function of the vegetative mycelium of ectomycorrhizal plants. I. Translocation of ¹⁴C-labelled carbon between plants interconnected by a common mycelium. New Phytol. 103:143-156.
8. Giovannetti, M. and B. Mosse. 1980. An evaluation of techniques for estimating vesicular-arbuscular mycorrhizal infection in roots. New Phytol. 84: 489-500.
9. Govindarajan, A. G., and S. E. Lindow. 1988. Phospholipid requirement for expression of ice nuclei in Pseudomonas syringae and in vitro. J Biol Chem 263:9333-8.
10. Grgurina, I., F. Mariotti, V. Fogliano, M. Gallo, A. Scaloni, N. S. Iacobellis, P. Lo Cantore, L. Mannina, V. van Axel Castelli, M. L. Greco, and A. Graniti. 2002. A new syringopeptin produced by bean strains of Pseudomonas syringae pv. syringae. Biochim Biophys Acta 1597:81-9.
11. Gross, D. C., Y. S. Cody, J. Proebsting, G. K. Radamaker, and R. A. Spotts. 1984. Ecotypes and pathogenicity of ice-nucleation-active Pseudomonas syringae isolated from deciduous fruit tree orchards. Phytopathol. 74:241-348.
12. Gurian-Sherman, D., and S. E. Lindow. 1993. Bacterial ice nucleation: significance and molecular basis. FASEB J. 7:1338-43.
13. Harley, J. L., and S. E. Smith. 1983. Mycorrhizal symbiosis. Academic Press, Inc, London.
14. Humphreys, T. L., L. A. Castrillo, and M. R. Lee. 2001. Sensitivity of partially purified ice nucleation activity of Fusarium acuminatum SRSF 616. Curr Microbiol 42:330-8.
15. Iacobellis, N. S., P. Lavermicocca, G. Surico, and R. D. Durbin. 1992. The occurrence and characterization of a syringomycin-macromolecular complex in cultures of Pseudomonas syringae pv. syringae. Physiol Mol Plant Pathol. 40:91-105.
16. Isogai, A., J. Iguchi, J. Nakayama, A. Kusai, J. Takemoto, and A. Suzuki. 1995. Structural analysis of new syringopeptins by tandem mass spectroscopy. Biosci Biotech Biochem 59:1374-137.
17. Jenkins, W. R. 1964. A rapid centrifugal flotation technique for separating nematodes from soil. Plant Dis Rep. 48: 692.bg
18. Kajava, A. V., and S. E. Lindow. 1993. A model of the three-dimensional structure of ice nucleation proteins. J Mol Biol 232:709-17.
19. Kormanick, P. P. and A. C. McGraw. 1982. Quantification of vesicular-arbuscular mycorrhizae in plant roots. In Methods and Principles of Mycorrhiza Research, Ed N. Schenck, APS Press, St. Paul.
20. Kozloff, L. M., M. A. Turner, F. Arellano, and M. Lute. 1991. Phosphatidylinositol, a phospholipid of ice-nucleating bacteria. J Bacteriol 173:2053-60.
21. Kropp, B. R., and S. Albee. 1998. Biodiversity inventory of mycorrhizal, rare and edible fungi. Final Project Report submitted to Wallowa-Whitman National Forest.
22. Lindow, S. E., D. C. Arny, and C. D. Upper. 1978. Distribution of ice nucleation-active bacteria on plants in nature. Appl Environ Microbiol 36:831-8.
23. Lindow, S. E., E. Lahue, A. G. Govindarajan, N. J. Panopoulos, and D. Gies. 1989. Localization of ice nucleation activity and the iceC gene product in Pseudomonas syringae and Escherichia coli. Mol Plant Microbe Interact 2:262-72.
24. Ludwig, J. A. and J. F. Reynolds. 1988. Statistical Ecology. John Wiley and Sons, New York.
25. Maki, L. R., E. L. Galyan, M. M. Chang-Chien, and D. R. Caldwell. 1974. Ice nucleation induced by Pseudomonas syringae. Appl Microbiol 28:456-9.
26. Marx, D. H. 1969. The influence of ectotrophic mycorrhizal fungi on the resistance of pine roots to pathogenic infections. I. Antagonism of mycorrhizal fungi to root pathogenic fungi and soil bacteria. Phytopathol. (supplement) 59:153-163.
27. Miller, O. K. 1982. Taxonomy of ecto- and ectendomycorrhizal fungi., p. 91-101. In N. C. Schenck (ed.), Methods and principles of mycorrhiza research. American Phytopathology Society, St. Paul.
28. Mueller, G. M., P. K. Wolber, and G. J. Warren. 1990. Clustering of ice nucleation protein correlates with ice nucleation activity. Cryobiology 27:416-22.
29. Palaiomylitou, M. A., A. Kalimanis, A. I. Koukkou, C. Drainas, E. Anastassopoulos, N. J. Panopoulos, L. V. Ekateriniadou, and D. A. Kyriakidis. 1998. Phospholipid analysis and fractional reconstitution of the ice nucleation protein activity purified from Escherichia coli overexpressing the inaZ gene of Pseudomonas syringae. Cryobiol. 37:67-76.
30. Porter, W. M. 1979. The most probable number method for enumerating infective propagules of vesicular arbuscular mycorrhizal fungi in soil. Aust J Soil Res. 17: 515-519.
31. Schmid, D., D. Pridmore, G. Capitani, R. Battistutta, J. R. Neeser, and A. Jann. 1997. Molecular organisation of the ice nucleation protein InaV from Pseudomonas syringae. FEBS Lett 414:590-4.
32. Segre, A., R. C. Bachmann, A. Ballio, F. Bossa, I. Grgurina, N. S. Iacobellis, G. Marino, P. Pucci, M. Simmaco, and J. Y. Takemoto. 1989. The structure of syringomycins A1, E and G. FEBS Lett. 255:27-31.
33. Shannon, C. F. and W. Weaver. 1949. The mathematical theory of communication. Univ. Illinois Press, Urbana.
34. Simpson, E. H. 1949. The measurement of diversity. Nature 163: 688.
35. Sorensen, K., K.-H. Kim, and J. Takemoto. 1998. PCR detection of cyclic lipodepsinonapeptide-producing Pseudomonas syringae pv. syringae and similarity of strains. App Environ Microbiol 64:226-230.
36. Sorensen, K. N., K. H. Kim, and J. Y. Takemoto. 1996. In vitro antifungal and fungicidal activities and erythrocyte toxicities of cyclic lipodepsinonapeptides produced by Pseudomonas syringae pv. syringae. Antimicrob Agents Chemother. 40:2710-2713.
37. Sorensen, K. N., A. A. Wanstrom, S. D. Allen, and J. Y. Takemoto. 1998. Efficacy of syringomycin E in a murine model of vaginal candidiasis. J Antibiotics 51:743-749.
38. Takemoto, J. Y., J. G. Brand, Y. A. Kaulin, V. V. Malev, L. V. Schagina, and K. Blasko. 2003. The syringomycins:lipodepsipeptide pore formers from plant bacterium, Pseudomonas syringae, p. 260-271. In G. Menestrina, M. D. Serra, and P. Lazarovici (ed.), Pore Forming Peptides and Protein Toxins. Harwood, London.
39. Trappe, J. M. 1962. Fungus associates of ectotrophic mycorrhizae. Bot Rev 28:538-606.
40. Turner, M. A., F. Arellano, and L. M. Kozloff. 1991. Components of ice nucleation structures of bacteria. J Bacteriol 173:6515-27.
41. Wipf, S., C. Rixen, M. Freppaz, and V. Stoeckli. 2002. Ski piste vegetation under artificial and natural snow: patterns in multivariate analysis. In Ecological interrelations in mountain ecosystems. Eds R. Bottarin and U. Tappeiner, Blackwell Verlag, Berlin
42. Wolber, P., and G. Warren. 1989. Bacterial ice-nucleation proteins. Trends Biochem Sci 14:179-82.

What is claimed is:

1. A method for eliminating the fungicidal activity of an ice nucleating bacteria solution comprising raising the pH of said ice nucleating bacteria solution to a high pH under sufficient conditions to eliminate the fungicidal activity of said ice nucleating bacteria solution.

2. A method according to claim 1 wherein the ice nucleating bacteria solution comprises an ice nucleating bacteria selected from the group consisting of Pseudomonas syringae, any species of the Pseudomonas genus, any species of the Xanthomonas genus and any species of the Erwinia genus.

3. A method according to claim 1 wherein raising the pH of said ice nucleating bacteria solution is by adjusting the pH with a base.

4. A method according to claim 3 wherein said base is selected from the group consisting of NaOH, KOH, MgOH, CaOH, ammonium hydroxide, and organic amines.

5. A method according to claim 1 wherein said high pH is at least above about 7.0.

6. A method according to claim 5 wherein said high pH is from about 7.1 to about 8.5.

7. A method according to claim 6 wherein said high pH is from about 7.5 to about 8.0.

8. A method according to claim 7 wherein said high pH is about 8.0.

9. A method according to claim 1 wherein said sufficient conditions to eliminate the fungicidal activity comprise a sufficient time period and a sufficient temperature.

10. A method according to claim 9 wherein said sufficient time period is from about 1 to about 60 minutes.

11. A method according to claim 10 wherein said sufficient time period is from about 1 to about 30 minutes.

12. A method according to claim 11 wherein said sufficient time period is about 15 minutes.

13. A method according to claim 9 wherein a sufficient temperature is from about 10° C. to about 50° C.

14. A method according to claim 13 wherein a sufficient temperature is from about 20° C. to about 40° C.

15. A method according to claim 14 wherein said sufficient temperature is about 25° C.

16. A method for enhancing fungi compatible artificial snow making comprising applying a fungi compatible ice nucleating bacteria solution produced according to claims 1 to 15 to a target area under conditions suitable for artificial snow making.

17. A method according to claim 16 wherein said target area is selected from the group consisting of a recreation area and permafrost maintenance zone.
